(19) United States
(12) Patent Application Publication
(10) Pub. No.: US 2026/0214566 A1
(43) Pub. Date: Jul. 23, 2026

(54) SYSTEMS AND METHODS FOR ENERGY USE OPTIMIZATION OF A POPULATION OF CONNECTED DEVICES

(71) Applicant: Zona NewCo, LLC, Brooklyn, NY (US)

(72) Inventors: Gary Adams, Golden Valley, MN (US); Michael Siemann, Golden Valley, MN (US); David Kaufman, Scottsdale, AZ (US)

(73) Assignee: Zona NewCo, LLC, Brooklyn, NY (US)

(21) Appl. No.: 19/142,993

(22) PCT Filed: Dec. 28, 2023
(86) PCT No.: PCT/US2023/086276

§ 371 Date: Jun. 25, 2025

Related U.S. Application Data
(60) Provisional application No. 63/435,694, filed on Dec. 28, 2022.

(51) Int. Cl. H04W 52/02; H04W 84/12

(52) U.S. Cl. CPC H04W 52/0203; H04W 84/12

(57) ABSTRACT

Systems and methods of the present disclosure enable improved management and optimization of energy use of connected devices. The systems and methods include receiving device use data from a connected devices in a predefined area and determining a time-based energy demand associated with each connected device based on the device use data. Time-of-use metrics for energy demand across the predefined area may be determined based on the time-based energy demand of each connected device. Active connected devices of the connected devices may be identified based on the device use data, and the active connected devices may be ranked according to a priority of operation. A subset of the active connected devices may be automatically instructed to operate at a low power operating mode during the window of time based on the ranking so as to reduce energy′ demand within the predefined area during the time window.

### CROSS-REFERENCE TO RELATED APPLICATION

This application claims the benefit of, and priority to, U.S. Provisional Patent Application No. 63/435,694, filed Dec. 28, 2022, its entirety of which is incorporated herein by reference.

### FIELD OF TECHNOLOGY

The present disclosure generally relates to computer-based platforms/systems and methods configured for optimization of energy use of a population of connected devices, including time-of-use optimization and reduction of excess energy demand.

### BACKGROUND OF TECHNOLOGY

As the use of connected devices, such as Internet-of-Things capable appliances, actuators, computing devices and other devices, proliferate, the energy demand of the connected devices rises. Thus, the connected devices can cause an increase in peak energy demand and variability in energy demand.

### SUMMARY OF DESCRIBED SUBJECT MATTER

In some aspects, the techniques described herein relate to a method including: receiving, by at least one processor, device use data from a plurality of connected devices in a predefined area; wherein the plurality of connected devices interface with the at least one processor via a network to enable the at least one processor to do at least one of the following: communicate with each connected device of the plurality of connected devices, or control each connected device of the plurality of connected devices; wherein the device use data includes operational characteristics including at least one of: on/off time, runtime, operating mode, power/current draw, power state, or setpoint; determining, by the at least one processor, a time-based energy demand associated with each connected device based at least in part on the device use data; determining, by the at least one processor, at least one time-of-use metric associated with energy demand across the predefined area based at least in part on the time-based energy demand associated with each connected device; determining, by the at least one processor, that the at least one time-of-use metric exceeds a predetermined time-of-use threshold that represents a maximum energy demand allowable by the plurality of connected devices within a window of time; determining, by the at least one processor, a plurality of active connected device of the plurality of connected devices based at least in part on the device use data indicating active usage of the plurality of active connected devices during the window of time; determining, by the at least one processor, a priority rank representing an ordering of the plurality of active connected devices according to a priority of operation based at least in part on: a device type of each active connected device of the plurality of active connected devices, the time-based energy demand associated with each active connected device, and the window of time; determining, by the at least one processor, at least one active connected device of the plurality of active connected devices having a low power operating mode that consumes less power than a current operating mode at which the at least one active connected device is operating; and automatically instructing, by the at least one processor, a subset of the plurality of active connected devices to operate at the low power operating mode during the window of time based at least in part on the priority rank and the at least one active connected device having the low power operating mode so as to reduce energy demand within the predefined area during the time window.

In some aspects, the techniques described herein relate to a method, wherein the plurality of active connected devices includes at least one WiFi router.

In some aspects, the techniques described herein relate to a method, further including: utilizing, by the at least one processor, at least one energy prediction model to predict a future time window energy metric associated with each connected device of the plurality of connected devices based at least in part on trained parameters and historical use data associated with the plurality of connected devices; determining, by the at least one processor, a priority rank representing an ordering of the plurality of active connected devices according to a priority of operation based at least in part on the future time window energy metric associated with each connected device.

In some aspects, the techniques described herein relate to a method, further including: utilizing, by the at least one processor, at least one energy prediction model to predict the time-based energy demand associated with each connected device based at least in part on the device use data and trained parameters.

In some aspects, the techniques described herein relate to a method, wherein the predefined area includes a service area of a power supply company or energy market or both.

In some aspects, the techniques described herein relate to a method, wherein the time-based energy demand includes time-of-use energy demand.

In some aspects, the techniques described herein relate to a method, further including automatically instructing, by the at least one processor, the subset of the plurality of active connected devices to operate at the low power operating mode to optimize at least one aspect of energy demand.

In some aspects, the techniques described herein relate to a method, wherein the at least one aspect includes energy demand variance.

In some aspects, the techniques described herein relate to a method, wherein the at least one aspect includes an energy demand peak.

In some aspects, the techniques described herein relate to a method, further including: accessing, by the at least one processor, a device profile associated with each connected device, wherein the device profile includes an energy demand associated with each operating mode; determining, by the at least one processor, a duration in each operating mode during the time window for each connected device; and determining, by the at least one processor, the at least one time-of-use metric for each connected device based at least in part on: the energy demand associated with each operating mode, and duration in each operating mode.

In some aspects, the techniques described herein relate to a system including: at least one processor in communication with at least one non-transitory computer-readable medium having software instructions stored thereon, wherein the at least one processor, upon execution of the software instructions, is configured to: receive device use data from a plurality of connected devices in a predefined area; wherein the plurality of connected devices interface with the at least one processor via a network to enable the at least one processor to do at least one of the following: communicate with each connected device of the plurality of connected devices, or control each connected device of the plurality of connected devices; wherein the device use data includes operational characteristics including at least one of: on/off time, runtime, operating mode, power/current draw, power state, or setpoint; determine a time-based energy demand associated with each connected device based at least in part on the device use data; determine at least one time-of-use metric associated with energy demand across the predefined area based at least in part on the time-based energy demand associated with each connected device; determine that the at least one time-of-use metric exceeds a predetermined time-of-use threshold that represents a maximum energy demand allowable by the plurality of connected devices within a window of time; determine a plurality of active connected device of the plurality of connected devices based at least in part on the device use data indicating active usage of the plurality of active connected devices during the window of time; determine a priority rank representing an ordering of the plurality of active connected devices according to a priority of operation based at least in part on: a device type of each active connected device of the plurality of active connected devices, the time-based energy demand associated with each active connected device, and the window of time; determine at least one active connected device of the plurality of active connected devices having a low power operating mode that consumes less power than a current operating mode at which the at least one active connected device is operating; and automatically instruct a subset of the plurality of active connected devices to operate at the low power operating mode during the window of time based at least in part on the priority rank and the at least one active connected device having the low power operating mode so as to reduce energy demand within the predefined area during the time window.

In some aspects, the techniques described herein relate to a system, wherein the plurality of active connected devices includes at least one WiFi router.

In some aspects, the techniques described herein relate to a system, wherein the at least one processor, upon execution of the software instructions, is further configured to: utilize at least one energy prediction model to predict a future time window energy metric associated with each connected device of the plurality of connected devices based at least in part on trained parameters and historical use data associated with the plurality of connected devices; determine a priority rank representing an ordering of the plurality of active connected devices according to a priority of operation based at least in part on the future time window energy metric associated with each connected device.

In some aspects, the techniques described herein relate to a system, wherein the at least one processor, upon execution of the software instructions, is further configured to: utilize at least one energy prediction model to predict the time-based energy demand associated with each connected device based at least in part on the device use data and trained parameters.

In some aspects, the techniques described herein relate to a system, wherein the predefined area includes a service area of a power supply company or energy market.

In some aspects, the techniques described herein relate to a system, wherein the time-based energy demand includes time-of-use energy demand.

In some aspects, the techniques described herein relate to a system, wherein the at least one processor, upon execution of the software instructions, is further configured to automatically instruct the subset of the plurality of active connected devices to operate at the low power operating mode to optimize at least one aspect of energy demand.

In some aspects, the techniques described herein relate to a system, wherein the at least one aspect includes energy demand variance.

In some aspects, the techniques described herein relate to a system, wherein the at least one aspect includes an energy demand peak.

In some aspects, the techniques described herein relate to a system, wherein the at least one processor, upon execution of the software instructions, is further configured to: access a device profile associated with each connected device, wherein the device profile includes an energy demand associated with each operating mode; determine a duration in each operating mode during the time window for each connected device; and determine the at least one time-of-use metric for each connected device based at least in part on: the energy demand associated with each operating mode, and duration in each operating mode.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 depicts an energy management system 110 for optimizing the energy use of a network 102 of connected devices 101 in accordance with at least one aspect of at least one embodiments of the present disclosure.

FIG. 2 depicts a flowchart illustrating a method of operation of the energy management system 110 for optimizing the energy use of a network 102 of connected devices 101 in accordance with at least one aspect of at least one embodiments of the present disclosure.

FIG. 3 depicts a flowchart illustrating a method of operation of energy prediction engine 130 of the energy management system 110 for optimizing the energy use of a network 102 of connected devices 101 in accordance with at least one aspect of at least one embodiments of the present disclosure.

FIG. 4 depicts a flowchart illustrating a method of optimizing the energy use of a network 102 of connected devices 101 in accordance with at least one aspect of at least one embodiments of the present disclosure.

FIG. 5 depicts a block diagram of ecosystem 500 incorporating the energy management system 110 in accordance with one or more embodiments of the present disclosure.

FIG. 6 depicts a block diagram of ecosystem 500 incorporating the energy management system 110 in accordance with one or more embodiments of the present disclosure.

FIG. 7 depicts illustrative schematics of an exemplary implementation of the cloud computing/architecture(s) in which embodiments of a system for the energy management system 110 may be specifically configured to operate in accordance with some embodiments of the present disclosure.

FIG. 8 depicts illustrative schematics of another exemplary implementation of the cloud computing/architecture(s) in which embodiments of a system for the energy management system 110 may be specifically configured to operate in accordance with some embodiments of the present disclosure.

### DETAILED DESCRIPTION

Various detailed embodiments of the present disclosure, taken in conjunction with the accompanying FIGs., are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or”, or with the conjunction “and.” In either case, the set is to be interpreted as meaning each of the items singularly as alternatives, as well as any combination of the listed items.

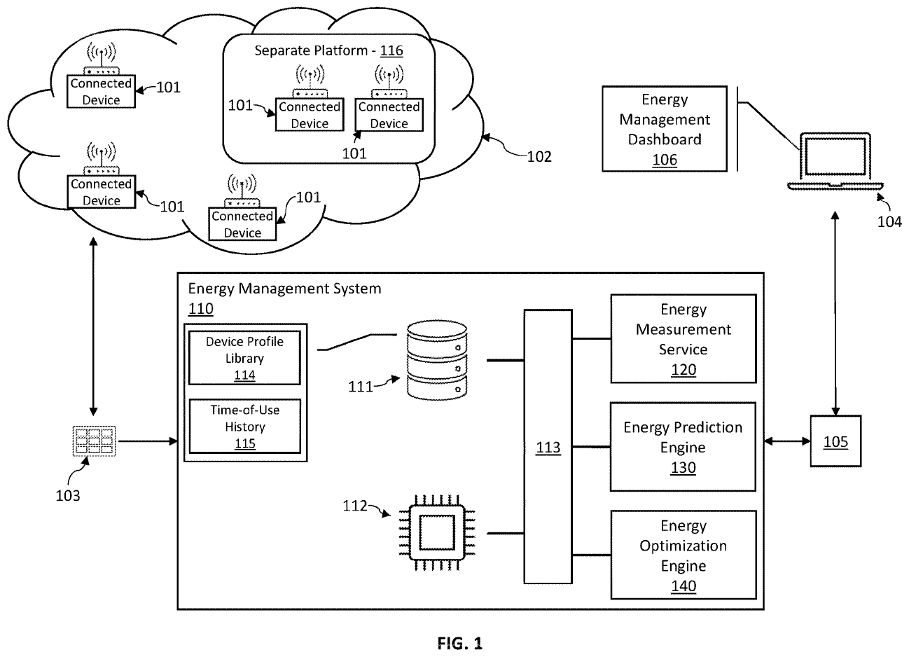

FIGS. 1 through 8 illustrate systems and methods of energy use optimization of connected devices. The following embodiments provide technical solutions and technical improvements that overcome technical problems, drawbacks and/or deficiencies in the technical fields involving excess power/energy draw by power consuming devices that are not utilized and/or utilized at inefficient times. As explained in more detail, below, technical solutions and technical improvements herein include aspects of improved control of connected devices to schedule and configure operation so as to optimize a time-based energy use of the connected devices, thereby reducing peak energy demand and enabling more efficient and consistent energy demand through time. Based on such technical features, further technical benefits become available to users and operators of these systems and methods. Moreover, various practical applications of the disclosed technology are also described, which provide further practical benefits to users and operators that are also new and useful improvements in the art.

FIG. 1 depicts an energy management system 110 for optimizing the energy use of a network 102 of connected devices 101 in accordance with at least one aspect of at least one embodiments of the present disclosure.

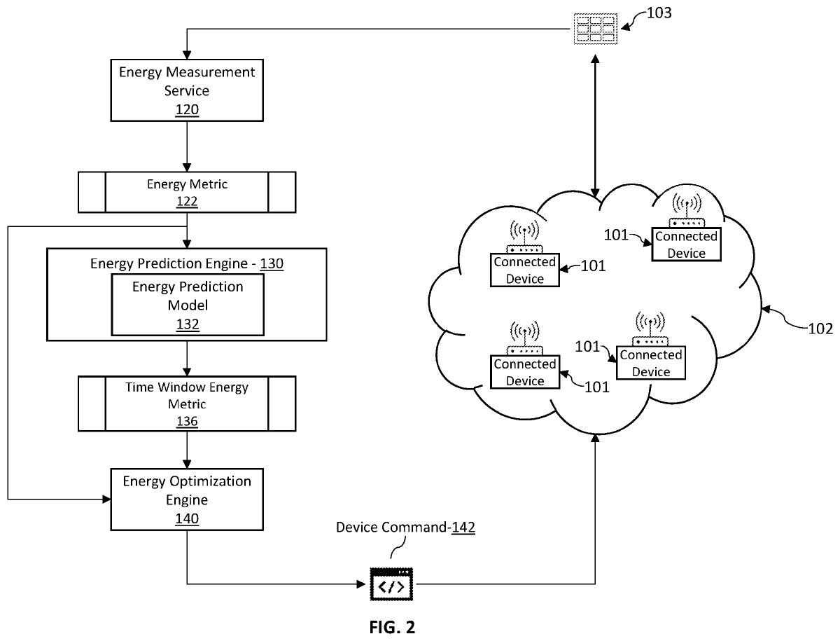

FIG. 2 depicts a flowchart illustrating a method of operation of the energy management system 110 for optimizing the energy use of a network 102 of connected devices 101 in accordance with at least one aspect of at least one embodiments of the present disclosure.

In some embodiments, a multi-home network 102 of connected devices 101 be connected to an energy management system 110 for monitoring, control and optimization of power usage of the connected devices 101. In some embodiments, the connected devices 101 may include any internet and/or network connected devices, such as, e.g., a WiFi router, border gateway, smart thermostat, smart appliance, smart HVAC and/or smart HVAC actuators, smart lights, smart light switches, among other “smart” devices. Herein, the term “smart” refers to functionalities including, but not limited to, one or more of internet connected, local and/or cloud provided automated controls, control across a network, artificial intelligence and/or machine learning automation (either local, remote, cloud provided, or a combination thereof), or other functionalities greater than on-device manual control.

In some embodiments, the network 102 may include any suitable computer network, including, two or more computers that are connected with one another for the purpose of communicating data electronically. In some embodiments, the network may include a suitable network type, such as, e.g., a public switched telephone network (PTSN), an integrated services digital network (ISDN), a private branch exchange (PBX), a wireless and/or cellular telephone network, a computer network including a local-area network (LAN), a wide-area network (WAN) or other suitable computer network, or any other suitable network or any combination thereof. In some embodiments, a LAN may connect computers and peripheral devices in a physical area by means of links (wires, Ethernet cables, fiber optics, wireless such as Wi-Fi, etc.) that transmit data. In some embodiments, a LAN may include two or more personal computers, printers, and high-capacity disk-storage devices, file servers, or other devices or any combination thereof. LAN operating system software, which interprets input and instructs networked devices, may enable communication between devices to: share the printers and storage equipment, simultaneously access centrally located processors, data, or programs (instruction sets), and other functionalities. Devices on a LAN may also access other LANs or connect to one or more WANs. In some embodiments, a WAN may connect computers and smaller networks to larger networks over greater geographic areas. A WAN may link the computers by means of cables, optical fibers, or satellites, cellular data networks, or other wide-area connection means. In some embodiments, an example of a WAN may include the Internet.

In some embodiments, the connected devices 101 may be electrically powered devices that operate intermittently, such as by user command, automated triggers (e.g., setpoints on comfort systems such as HVAC and thermostat, security systems, etc.), predetermined or autogenerated schedules, among other intermittent operation triggers or any combination thereof. Thus, the connected devices 101 may operate at overlapping times causing peaks in energy demand.

In some embodiments, the connected devices 101 may operate continuously. For example, a WiFi router, border gateway, water boiler, refrigerator, or other device that operates continuously. Thus, the connected devices 101 may be in operation even when the connected devices 101 are not providing utility to a user. For example, a WiFi router operates twenty four hours a day, seven days a week, but may only be used by user devices during waking hours, or outside of work hours, and thus may be in operation but not actively used during the night or while the user is at work or at any other times where the user is not actively using the WiFi router.

For both continuously operating connected devices 101 and intermittently operating connected devices 101, there are times where operation contributes to unnecessary energy demand. Thus, in some embodiments, an energy management system 110 may be employed to provide energy management to optimize the operational schedules of the connected devices 101 to optimize the efficiency of energy demand throughout a period of time. In some embodiments, optimized efficiency may refer to a minimization of peak demand, a maximization of energy demand uniformity throughout the period of time, a minimization of energy demand variability throughout the period of time, a maximization of energy demand during “off-peak” hours, or other suitable optimization target for the energy demand of the connected devices 101 or any combination thereof.

In some embodiments, the energy management system 110 may include hardware components such as a processor 111, which may include local or remote processing components. In some embodiments, the processor 111 may include any type of data processing capacity, such as a hardware logic circuit, for example an application specific integrated circuit (ASIC) and a programmable logic, or such as a computing device, for example, a microcomputer or microcontroller that include a programmable microprocessor. In some embodiments, the processor 111 may include data-processing capacity provided by the microprocessor. In some embodiments, the microprocessor may include memory, processing, interface resources, controllers, and counters. In some embodiments, the microprocessor may also include one or more programs stored in memory.

Similarly, the energy management system 110 may include storage 112, such as one or more local and/or remote data storage solutions such as, e.g., local hard-drive, solid-state drive, flash drive, database or other local data storage solutions or any combination thereof, and/or remote data storage solutions such as a server, mainframe, database or cloud services, distributed database or other suitable data storage solutions or any combination thereof. In some embodiments, the storage 111 may include, e.g., a suitable non-transient computer readable medium such as, e.g., random access memory (RAM), read only memory (ROM), one or more buffers and/or caches, among other memory devices or any combination thereof.

In some embodiments, the energy management system 110 may implement computer engines for measurement of energy use on a per-device, per-area, per-house, per-time window, or other basis or any combination thereof, prediction of energy use during a next time window on a per-device, per-area, per-house, per-time window, or other basis or any combination thereof, and energy optimization of the operation of the connected devices 101 based on the measurement of energy use and/or the prediction of energy use. In some embodiments, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

In some embodiments, to generate energy-related metrics, the energy management system 110 may include, e.g., an energy management service 120. In some embodiments, the energy management service 120 may include dedicated and/or shared software components, hardware components, or a combination thereof. For example, the energy management service 120 may include a dedicated processor and storage. However, in some embodiments, the energy management service 120 may share hardware resources, including the processor 111 and storage 112 of the energy management system 110 via, e.g., a bus 113.

In some embodiments, to generate energy-related predictions, the energy management system 110 may include, e.g., an energy prediction engine 130. In some embodiments, the energy prediction engine 130 may include dedicated and/or shared software components, hardware components, or a combination thereof. For example, the energy prediction engine 130 may include a dedicated processor and storage. However, in some embodiments, the energy prediction engine 130 may share hardware resources, including the processor 111 and storage 112 of the energy management system 110 via, e.g., a bus 113.

In some embodiments, to optimize energy use and/or device use, the energy management system 110 may include, e.g., an energy optimization engine 140. In some embodiments, the energy optimization engine 140 may include dedicated and/or shared software components, hardware components, or a combination thereof. For example, the energy optimization engine 140 may include a dedicated processor and storage. However, in some embodiments, the energy optimization engine 140 may share hardware resources, including the processor 111 and storage 112 of the energy management system 110 via, e.g., a bus 113.

In some embodiments, the energy management system 110 may receive use data 103 from the network 102 of connected devices 101. In some embodiments, the energy management system 110 may be a part of the user computing device 101. Thus, the energy management system 110 may include hardware and software components including, e.g., user computing device 101 hardware and software, cloud or server hardware and software, or a combination thereof.

In some embodiments, the energy management system 110 may receive the use data 103 from each connected device 101, e.g., via a suitable messaging protocol and/or application protocol interface, or other suitable interface (e.g., HTTP, HTTPS, TCP/IP, etc.). In some embodiments, one or more interfaces may utilize one or more software computing interface technologies, such as, e.g., Common Object Request Broker Architecture (CORBA), an application programming interface (API) and/or application binary interface (ABI), among others or any combination thereof. In some embodiments, an API and/or ABI defines the kinds of calls or requests that can be made, how to make the calls, the data formats that should be used, the conventions to follow, among other requirements and constraints. An “application programming interface” or “API” can be entirely custom, specific to a component, or designed based on an industry-standard to ensure interoperability to enable modular programming through information hiding, allowing users to use the interface independently of the implementation. In some embodiments, CORBA may normalize the method-call semantics between application objects residing either in the same address-space (application) or in remote address-spaces (same host, or remote host on a network).

Herein, the term “application programming interface” or “API” refers to a computing interface that defines interactions between multiple software intermediaries. An “application programming interface” or “API” defines the kinds of calls or requests that can be made, how to make the calls, the data formats that should be used, the conventions to follow, among other requirements and constraints. An “application programming interface” or “API” can be entirely custom, specific to a component, or designed based on an industry-standard to ensure interoperability to enable modular programming through information hiding, allowing users to use the interface independently of the implementation.

In some embodiments, the network 102 may include one or more distinct networks, a network of one or more distinct sub-networks, a logical network (e.g., a set of connected devices 101 in communication with the energy management system 110 but on a common network infrastructure) or any combination of wide area, local area, and/or virtual/logical networks.

In some embodiments, the connected devices 101 may be associated with different ecosystems, such as, e.g., different smart home platforms (e.g., Apple Homekit™, Google Home™, Amazon Alexa™, Honeywell Home™, Resideo Connect™, GE Cync™, etc.). Thus, the energy management system 110 may be in communication with the smart home platform of each connected device 101 rather than directly with each connected device 101 itself, e.g., via a cloud-to-cloud ecosystem. Thus, energy management and optimization of connected devices 101 that are not directly compatible with the energy management system 110 may nevertheless be managed and optimized via cloud-to-cloud communication with the platform(s) associated with the connected devices 101. In some embodiments, some or all connected devices 101 may in direct communication with the energy management system 110, some or all of the connected devices 101 may be directly managed by a separate platform through which the energy management system 110 may interface to indirectly manage and control those some or all connected devices 101, or any combination of direct and indirect management and optimization of the connected devices 101.

In some embodiments, to communicate with the connected devices 101 and/or platform associated with the connected devices 101 via the network 102, the energy management system 110 may employ one or more APIs. In some embodiments, the API(s) may provide the energy management system 110 access to the use data 103 of each connected device 101. In some embodiments, the API(s) may also enable a user computing device 104 associated with a user, such as an individual owner of one or more connected devices 101, a commercial entity that owners one or more of the connected devices 101, a property management entity that manages properties associated with one or more connected devices 101, an energy supply/power supply entity that provides power to an area associated with one or more of the connected devices 101, one or more energy markets, among other entities or any combination thereof.

For example, the user may be a utility such as power supply company, or may be one or more energy markets, or any combination thereof. Thus, the connected devices 101 associated with the power supply company may include the connected devices 101 within a particular geographic area for which the utility provides power. The utility may leverage the API(s) with the energy management system 110 to perform time-of-use energy management via adjustments to parameters, setpoints and/or schedules of the connected devices 101.

In another example, the user may be a home owner such that the connected devices 101 associated with the user are the connected devices 101 located with the homeowner's home and/or the connected devices 101 registered to a user account of the user. Thus, the homeowner may leverage the API(s) with the energy management system 110 to perform time-of-use energy management in the home via adjustments to parameters, setpoints and/or schedules of the connected devices 101.

Accordingly, in some embodiments, the API may provide the user interfacing, e.g., via an energy management dashboard 106, that provides controls to the user to set parameters of connected devices 101, set schedules and/or setpoints of connected devices 101, view the use data 103 of the connected devices 101, and/or perform other tasks and actions relative to the connected devices 101 associated with the user. Thus, the energy management system 110 may provide services that enable management of the connected devices 101 in the network 102 to one or more users of the connected devices 101, while also providing energy use optimizations to the connected devices 101.

In some embodiments, to optimize energy use of the connected devices 101, the energy management system 110 may receive the use data 103 of each connected device 101. The energy management system 110 may receive the use data 103 as a continuous stream and/or in periodic batches (e.g., once per hour, once per three hours, once per four hours, once per six hours, once per eight hours, once per twelve hours, once per day, once per night, once per week, once per month, etc.).

In some embodiments, the use data 103 may include, e.g., On/off time, Runtime, Operating mode, Power/current draw, Power state (on/off/standby/etc), Setpoint (e.g., comfort system setpoint), among other data that characterizes usage patterns and power levels of each connected device 101. In some embodiments, the connected devices 101 may include a variety of different devices. Thus, the use data 103 may vary based on the device type of each connected device 101. For example, a WiFi router may have use data including download bandwidth use, upload bandwidth use, processor clock speed, operating mode, power state, etc. In another example, a refrigerator may have use data including, e.g., refrigerator temperature setpoint, freezer temperature setpoint, duration and/or times of active cooling, interior refrigerator temperature, interior freezer temperature, component use times/durations (e.g., ice maker actuation, water dispenser actuation, etc.), etc. In another example, an HVAC system may have use data including, e.g., temperature setpoint, ambient temperature, ambient humidity, power state, operating mode, etc.

In some embodiments, the energy management system 110 may employ an energy measurement service 120 to analyze the use data to extract and/or derive energy demand attributable to each connected device 101. The energy demand may be an instantaneous energy demand (e.g., at a particular point in time), or a periodic energy demand (e.g., for a particular window of time).

In some embodiments, the user may use the energy management dashboard 106 to define a set of connected devices 101 to manage. In some embodiments, the set of connected devices may be selected based on any suitable grouping of the connected devices associated with the user, e.g., types, sizes, area (such as a geographic area) or other grouping or any combination thereof. The geographic area may be defined by, e.g., street, neighborhood, borough, district, town, city, county, region, territory, state, country, latitude-longitude, range of latitudes and/or longitudes, among other definitions of geographic area. In some embodiments, the area may be a set of one or more addresses. Thus, the user may select, via the energy management dashboard 106, a geographic location, address(es), room(s) within a structure at a particular address/location, particular device(s), particular device type(s), among other grouping of the connected devices 101.

In some embodiments, the location of connected devices 101 may be included in the use data 103, in device profiles stored in a device profile library 114 of the storage 111, and/or inferred/derived. For example, the energy measurement services 120 may infer a location for one or more connected devices 101 based on, e.g., location-specific characteristics (e.g., weather, elevation, nearby devices, etc.).

In some embodiments, based on the selection, or automatically for all connected devices 101 associated with the user, or both, the energy measurement service 120 may determine time-dependent energy demand attributable to the connected devices 101. In some embodiments, energy measurement service 120 may derive energy use using one or more algorithms based on the use data 103.

In some embodiments, the energy measurement service 120 may derive energy use by identifying the device. The use data 103 may include a device identifier that uniquely identifies each connected device 101. Using the device identifier, the energy measurement service 120 may query the device profile library 114 for a device profile associated with the connected device 101. In some embodiments, the device profile may include device characteristics such as, e.g., a normal operating range of a power state-specific and/or operating mode-specific power draw for the device, among other energy consumption related data or any combination thereof. Thus, the energy management service 120 may use the operating mode and/or power state and/or on-off times of the connected device 101 along with the normal operating range of a power state-specific and/or operating mode-specific power draw for the device to determine an estimated amount of energy consumed. For example, the duration in a particular power state multiplied by the normal operating power draw in for the particular power state of the connected device 101 may produce the estimated energy consumed at a particular time or within a particular time window.

In some embodiments, the energy measurement service 120 may derive energy use by employing one or more energy inferencing machine learning algorithms. To do so, the energy measurement service 120 may identify the device, as detailed above, and query a time-of-use history 115 to retrieve a historical record of energy consumed by the connected device. In some embodiments, the energy inferencing machine learning model may be trained with the time-of-use history to correlate input data to an instantaneous power draw and/or energy consumed during a time window, where the input data may include on/off time, runtime, operating mode, setpoint, etc. To do so, in some embodiments, the energy inferencing machine learning model may include, e.g., an unsupervised learning model, such as a regression model, probabilistic model or other suitable learning model to develop the correlation based on past data.

In some embodiments, the energy measurement service 120 may be configured to utilize one or more exemplary AI/machine learning techniques chosen from, but not limited to, decision trees, boosting, support-vector machines, neural networks, nearest neighbor algorithms, Naive Bayes, bagging, random forests, and the like. In some embodiments and, optionally, in combination of any embodiment described above or below, an exemplary neutral network technique may be one of, without limitation, feedforward neural network, radial basis function network, recurrent neural network, convolutional network (e.g., U-net) or other suitable network. In some embodiments and, optionally, in combination of any embodiment described above or below, an exemplary implementation of Neural Network may be executed as follows:
a. define Neural Network architecture/model,
b. transfer the input data to the exemplary neural network model,
c. train the exemplary model incrementally,
d. determine the accuracy for a specific number of timesteps,
e. apply the exemplary trained model to process the newly-received input data,
f. optionally and in parallel, continue to train the exemplary trained model with a predetermined periodicity.

In some embodiments and, optionally, in combination of any embodiment described above or below, the exemplary trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the exemplary trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the exemplary aggregation function may be a mathematical function that combines (e.g., sum, product, etc.) input signals to the node. In some embodiments and, optionally, in combination of any embodiment described above or below, an output of the exemplary aggregation function may be used as input to the exemplary activation function. In some embodiments and, optionally, in combination of any embodiment described above or below, the bias may be a constant value or function that may be used by the aggregation function and/or the activation function to make the node more or less likely to be activated.

In some embodiments, the energy management service 120 may extract the energy use directly from the use data 103. For example, a particular connected device 101 may have an onboard power meter, ammeter, voltmeter, or other suitable energy and/or energy metering mechanism or any combination thereof. Alternatively, or in addition, the connected device 101 and/or the area associated with the connected device 101 may include a utility meter other energy metering device external to the connected device 101.

In some embodiments, based on the extracted and/or inferred energy measurements, the energy measurement service 120 may generate time-dependent metrics for the area based on an aggregate of energy use of all connected devices 101, such as, e.g., a time-of-use energy consumption metric. Herein, the term “time-of-use” refers to the segregation of energy rates based on the time in which the energy is being consumed. Time-of-use may be a way in which utility providers attempt to alleviate demand during peak periods by enforcing a tariff structure that charges an increased rate within the typical peak consumption time periods.

In some embodiments, the time-dependent energy metric 122 may include energy demand, current demand, power demand, or other suitable unit of measuring demand through time. In some embodiments, the energy metric 122 may be instantaneous through time (e.g., a series of instantaneous points in time), a rolling average, a segmented by time window, for a current time window, for a historical time window, predictive for a future/next time window, or for any other period/point of time.

For example, the energy measurement service 120 may measure energy demand of the set of connected devices 101 and/or a particular connected device 101 and/or all connected devices 101 on a per time-window basis. The time windows may be discrete segments of a day (e.g., periods of 1, 2, 3, 4, 5, 6, 7, 8, 9, 10, 11, 12 or other number of hours in the day), for a rolling time window, or any other suitable definition of a time window. In some embodiments, the energy metric 122 for each time window may be a total energy consumed, an average energy consumed through time, or other quantitative characterization of the energy demand throughout the time window.

In some embodiments, where the energy metric 122 is predictive, the energy measurement service 120 may implement an energy demand prediction machine learning model. Similar to the energy inferencing machine learning model detailed above, the energy demand prediction machine learning model may identify the device, as detailed above, and query a time-of-use history 115 to retrieve a historical record of energy consumed by the connected device. In some embodiments, the energy demand prediction machine learning model may be trained with the time-of-use history to correlate input data to a future energy demand during a future time window, where the input data may include, e.g., the device identifier, time of day, day of week, ambient temperature/humidity, on/off time, runtime, operating mode, setpoint, etc. To do so, in some embodiments, the energy demand prediction machine learning model may include, e.g., an unsupervised learning model, such as a regression model, probabilistic model or other suitable learning model to develop the correlation based on past data.

In some embodiments, the energy measurement service 120 may be configured to utilize one or more exemplary AI/machine learning techniques chosen from, but not limited to, decision trees, boosting, support-vector machines, neural networks, nearest neighbor algorithms, Naive Bayes, bagging, random forests, and the like as detailed above.

In some embodiments, the energy metric 122 may quantify energy demand by a particular device, a device type, a sub-area with the area, across the whole area, for all devices, for an individual residence, for a business, associated with a particular entity, among other aggregations of connected devices 101.

In some embodiments, the energy management system 110 may send, transmit, communicate or otherwise provide energy management information 105 to one or more computing devices 104. The energy management information 105 may include the energy metric(s) 122 associated with the connected devices 101, visualizations, real-time use data (e.g., the use data 103), one or more available controls, etc.

In some embodiments, the user may view, via the energy management dashboard 106 of the computing device 104, the energy management information 105 including the energy metrics 122, to visualize the time-of-use energy metering in the area, broken down by device type, sub-area (e.g., a heat map), operating mode of each device, among other visualizations. For example, the visualization can be in the form of an energy management dashboard 106 on one or more computing devices 104, the energy management dashboard 106 having one or more visual components to represent time-of-use energy metering. The visualizations may include, e.g., data tables representing the relationship of device type to energy, data tables representing the relationship of time-of-use to energy, data tables representing the relationship of device type to energy through time (e.g., separate bars, lines, markers indicating device type-specific energy metering as a function of time), one or more heat maps showing energy metering throughout the area, one or more heat maps showing operating mode of one or more device types throughout the area, among other visualizations of the energy metrics 122 of the connected devices 101.

In some embodiments, the energy management dashboard 106 may include controls to enforce energy restrictions and/or provide incentives to optimize time-of-use or other time-dependent energy use characteristics of the connected devices 101. For example, the user may set restrictions on, e.g., energy demand thresholds that restrict energy demand from exceeding a threshold at a particular time, energy demand thresholds that restrict energy demand increasing at rate greater than a threshold at a particular time, energy demand thresholds that restrict energy demand peaking in a particular time window at a level greater than a particular threshold ratio relative to a minimum energy demand time window, among other thresholds and/or restrictions or any combination thereof.

In some embodiments, based on the restriction selected, the computing device 104 may return energy management information 105, e.g., via the API(s), to the energy management system 110 to cause the energy management system to optimize parameters of the connected devices 101 to achieve the selected restrictions. Alternatively, or in addition, the use may explicitly select changes to parameters of one or more connected devices 101. In some embodiments, the parameters may include, e.g., a different operating mode during a demand peak (e.g., an Eco mode, or other reduced energy mode), schedule operation to evenly distribute energy demand, adjust duty cycle of devices/appliances to evenly distribute energy demand, among other parameters governing operation of each connected device 101 or any combination thereof.

In some embodiments, the energy management system 110 may instantiate the energy optimization engine 140 to implement the instructions by automatically adjusting the connected devices 101 in a selected area to optimize energy use based on the restrictions. To do so, in some embodiments, the energy optimization engine 140 may use the energy demand of each device (e.g., based on the energy metric 122) and the connected devices 101 to determine an optimal combination of parameters that balances energy demand during a particular time window and a likelihood of a need of a person for a particular type of operation of each connected device during the particular time window.

In some embodiments, to determine a likelihood of a need of a person for a particular type of operation of each connected device during the particular time window, the energy optimization engine 140 may infer a prioritization of each connected device during the particular time window. To do so, the energy optimization engine 140 may determine a priority of each device relative to all connected devices 101 to establish devices that can be restricted from energy demand (e.g., via a lower power operating mode, turning off, etc.). In some embodiments, the energy optimization engine 140 may access the time-of-use history 115 of each connected device 101 and determine a priority score for use by a user of each connected device 101 during the particular time window, e.g., based on use patterns such as time of day, device type, typical usage patterns of the device, importance of the device, etc. For example, the use patterns may be analyzed with a set of predefined rules that map usage patterns to priority weights. The priority weights may then be aggregated into the priority score. The connected devices 101 may then be ranked for the particular time window by magnitude of priority score.

In some embodiments, the energy optimization engine 140 may call the energy prediction 130 to predict a time window energy metric 136 for the particular time window based on the usage patterns. To do so, the energy optimization engine 140 may utilize an energy prediction model 132 that models a correlation between input data and a quantification of usage of the connected device.

In some embodiments, the input data to the energy optimization engine 140 may include, e.g., the particular connected device 101, a device type of the particular connected device, a time of day of the particular time window, a day of the week of the particular time window, among other factors. In some embodiments, the quantification of the usage may include, e.g., a time window energy metric 136 that represents a predicted energy demand during the particular time window, a likelihood of use of the connected device 101 during the particular time window, a predicted operating mode/power state of the connected device 101 during the particular time window, an operation duration of the connected device 101 during the particular time window 101, among other quantifications of use of the connected device 101 or any combination thereof.

Alternatively, or in addition, the energy prediction model 132 may predict a schedule of energy demand of the connected devices 101 through all time windows. For example, the energy prediction model 132 may predict a time window energy metric 136 that represented a likely time of day of operation each connected device 101, e.g., based on average time of day of use according to historical use data and/or historical time of use data. Thus, the energy prediction model 132 may output a likely maximum energy demand, e.g., throughout a day, week, month or other period.

In some embodiments, based on the prioritization and/or time window energy metric 136 associated with each connected device 101 in each window throughout the period, the energy optimization engine 140 may automatically generate an optimal schedule for the operating mode/power state/operation of each connected device 101 in order to optimize time-dependent energy demand. For example, the energy optimization engine 140 may shift activation to a higher operating mode/power state of one or more connected devices 101 out of a time window having or projected to have a demand peak to another time window having or projected to have a demand minimum when the one or more connected devices 101 have lower priority than other connected devices 101 operational during the time window having or projected to have a demand peak. Thus, the energy optimization engine 140 may balance priority of operation of each connected device 101 in each time window, magnitude of energy demand (e.g., via the energy metric and/or predicted time window energy metric) of each connected device 101, and the overall pattern of energy demand through time to achieve an optimization including, e.g., minimized demand peak, minimized demand variance across time windows, maximized demand consistency across time windows, among other optimizations or any combination thereof.

In some embodiments, based on the optimization, the energy optimization engine 140 may generate one or more device commands 142 that represent instructions to one or more associated connected devices 101 to schedule operation/operating mode/power state to achieve the optimization. Thus, the energy optimization engine 140 may automatically control the connected devices 101 to optimize energy usage for more efficient, consistent and reliable energy demand through the period.

In some embodiments, the device command 142 may include, e.g., an operating mode restriction based on time of day, an operating mode restriction based on operating modes of other devices at a particular time, a notice to the owner to recommend operating one or more of the devices in another time window in order to enable a different operating mode, among other device commands 142 or any combination thereof.

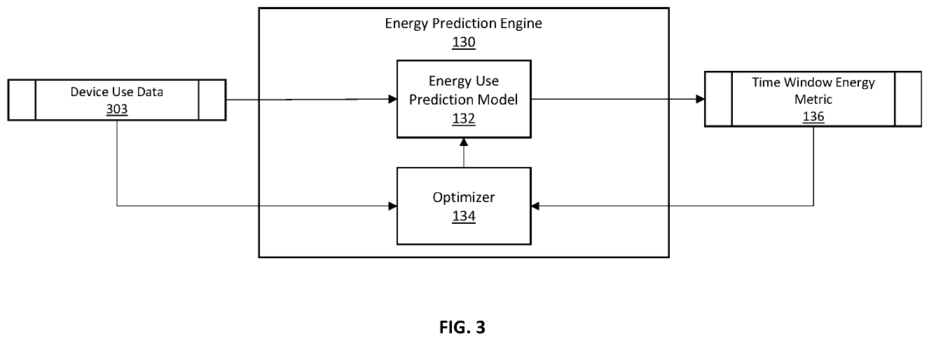

FIG. 3 depicts a flowchart illustrating a method of operation of energy prediction engine 130 of the energy management system 110 for optimizing the energy use of a network 102 of connected devices 101 in accordance with at least one aspect of at least one embodiments of the present disclosure.

In some embodiments, the energy prediction engine 130 may utilize the energy use prediction model 132 to predict an energy demand and/or time-of-use prediction in order to generate an adjustment to connected device operational parameters.

In some embodiments, the energy use prediction model 132 ingests a feature vector that encodes features representative of use data of the connected device(s), including, e.g., on-off times, operational state, operation mode, power mode, current draw, power draw, device type, device ID, device location, environmental data from an ambient environment, actuation occurrences and/or times, among other use data or any combination thereof. In some embodiments, the energy use prediction model 132 processes the feature vector with parameters to produces a prediction of energy demand by the connected device 101 in a particular time window. In some embodiments, the parameters of the energy use prediction model 132 may be implemented in a suitable machine learning model including a prediction machine learning model, such as, e.g., Linear Regression, Logistic Regression, Ridge Regression, Lasso Regression, Polynomial Regression, Bayesian Linear Regression (e.g., Naive Bayes regression), a convolutional neural network (CNN), a recurrent neural network (RNN), decision trees, random forest, support vector machine (SVM), K-Nearest Neighbors, or any other suitable algorithm for predicting output values based on input values. In some embodiments, for computational efficiency while preserving accuracy of predictions, the energy use prediction model 132 may advantageously include a random forest model.

In some embodiments, the energy use prediction model 132 processes the features encoded in the feature vector by applying the parameters of the prediction machine learning model to produce a model output vector. In some embodiments, the model output vector may be decoded to generate one or more numerical output values indicative of energy demand by the connected device 101 in a particular time window. In some embodiments, the model output vector may include or may be decoded to reveal the output value(s) based on a modelled correlation between the feature vector and a target output. In some embodiments, the numerical output may represent energy demand by the connected device 101 in a particular time window.

In some embodiments, the parameters of the energy use prediction model 132 may be trained based on known outputs. For example, the historical device use data 303 may be paired with a target value or known value to form a training pair, such as a historical device use data 303 and an observed result and/or human annotated value representing a data point in the relationship between the historical device use data 303 and energy demand by the connected device 101 in a particular time window. In some embodiments, the historical device use data 303 may be provided to the energy use prediction model 132, e.g., encoded in a feature vector, to produce a predicted output value. In some embodiments, an optimizer 134 associated with the energy use prediction model 132 may then compare the predicted output value with the known output of a training pair including the historical device use data 303 to determine an error of the predicted output value. In some embodiments, the optimizer 134 may employ a loss function, such as, e.g., Hinge Loss, Multi-class SVM Loss, Cross Entropy Loss, Negative Log Likelihood, or other suitable classification loss function to determine the error of the predicted output value based on the known output.

In some embodiments, the known output may be obtained after the energy use prediction model 132 produces the prediction, such as in online learning scenarios. In such a scenario, the energy use prediction model 132 may receive the historical device use data 303 and generate the model output vector to produce an output value representing energy demand by the connected device 101 in a particular time window. Subsequently, a user may provide feedback by, e.g., modifying, adjusting, removing, and/or verifying the output value via a suitable feedback mechanism, such as a user interface device (e.g., keyboard, mouse, touch screen, user interface, or other interface mechanism of a user device or any suitable combination thereof). The feedback may be paired with the historical device use data 303 to form the training pair and the optimizer 134 may determine an error of the predicted output value using the feedback.

In some embodiments, based on the error, the optimizer 134 may update the parameters of the energy use prediction model 132 using a suitable training algorithm such as, e.g., backpropagation for a prediction machine learning model. In some embodiments, backpropagation may include any suitable minimization algorithm such as a gradient method of the loss function with respect to the weights of the prediction machine learning model. Examples of suitable gradient methods include, e.g., stochastic gradient descent, batch gradient descent, mini-batch gradient descent, or other suitable gradient descent technique. As a result, the optimizer 134 may update the parameters of the energy use prediction model 132 based on the error of predicted labels in order to train the energy use prediction model 132 to model the correlation between historical device use data 303 and energy demand by the connected device 101 in a particular time window in order to produce more accurate output values based on historical device use data 303.

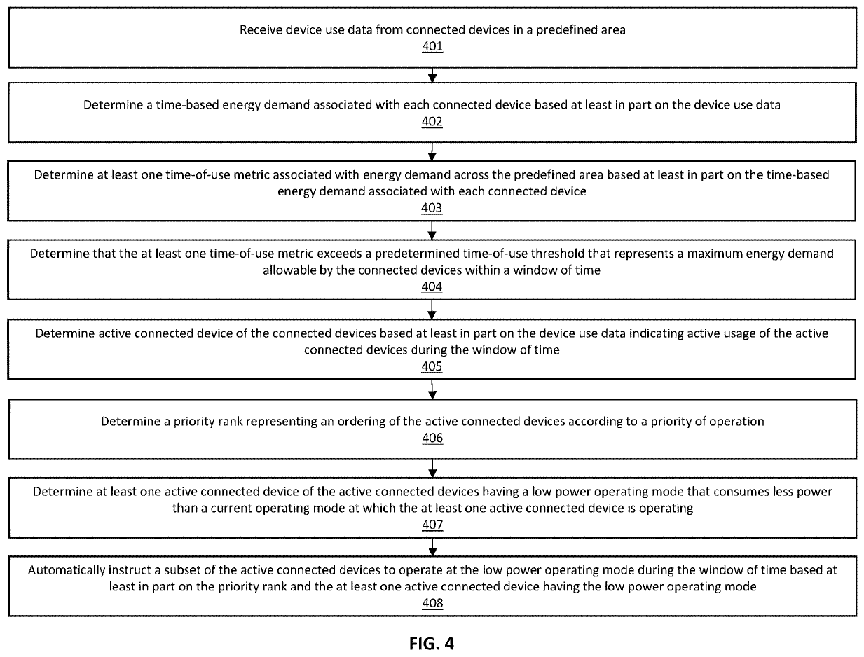

FIG. 4 depicts a flowchart illustrating a method of optimizing the energy use of a network 102 of connected devices 101 in accordance with at least one aspect of at least one embodiments of the present disclosure.

At block 401, in some embodiments, device use data is received from a connected devices in a predefined area.

In some embodiments, the connected devices interface with the at least one processor via a network to enable the at least one processor to do at least one of the following: communicate with each connected device of the connected devices, or control each connected device of the connected devices.

In some embodiments, the device use data comprises operational characteristics comprising at least one of: on/off time, runtime, operating mode, power/current draw, power state, or setpoint.

At block 402, in some embodiments, a time-based energy demand associated with each connected device is determined based at least in part on the device use data.

At block 403, in some embodiments, at least one time-of-use metric associated with energy demand across the predefined area is determined based at least in part on the time-based energy demand associated with each connected device.

At block 404, it is determined that the at least one time-of-use metric exceeds a predetermined time-of-use threshold that represents a maximum energy demand allowable by the connected devices within a window of time.

At block 405, in some embodiments, a active connected device of the connected devices is determined based at least in part on the device use data indicating active usage of the active connected devices during the window of time.

At block 406, in some embodiments, a priority rank representing an ordering of the active connected devices is determined according to a priority of operation based at least in part on a device type of each active connected device of the active connected devices, the time-based energy demand associated with each active connected device, and the window of time.

At block 407, in some embodiments, at least one active connected device of the active connected devices is determined having a low power operating mode that consumes less power than a current operating mode at which the at least one active connected device is operating.

At block 408, in some embodiments, a subset of the active connected devices is automatically instructed to operate at the low power operating mode during the window of time based at least in part on the priority rank and the at least one active connected device having the low power operating mode so as to reduce energy demand within the predefined area during the time window.

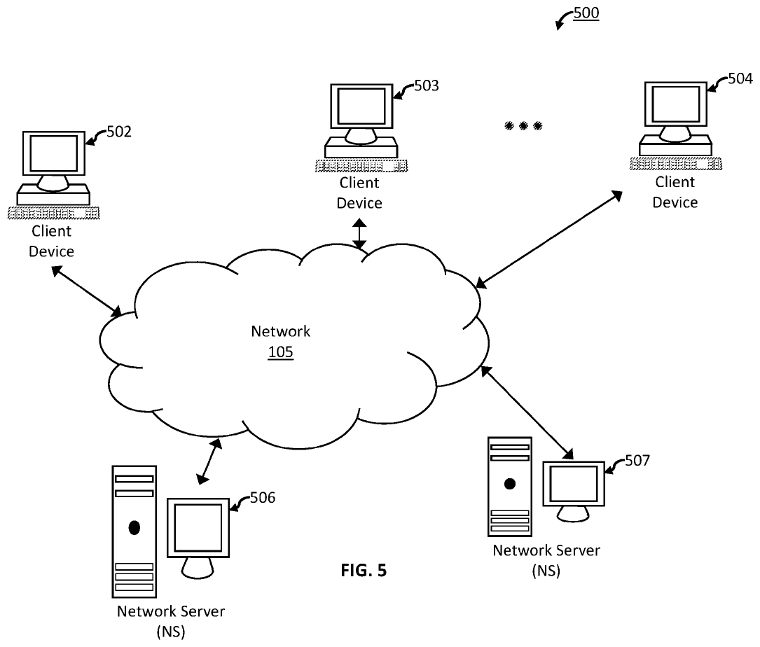

FIG. 5 depicts a block diagram of ecosystem 500 incorporating the energy management system 110 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the illustrative computing devices and the illustrative computing components of the exemplary computer-based system and platform 500 may be configured to manage a large number of members and concurrent transactions, as detailed herein. In some embodiments, the exemplary computer-based system and platform 500 may be based on a scalable computer and network architecture that incorporates varies strategies for assessing the data, caching, searching, and/or database connection pooling. An example of the scalable architecture is an architecture that is capable of operating multiple servers.

In some embodiments, referring to FIG. 5, connected device 502, connected device 503 through connected device 504 (e.g., clients) of the exemplary computer-based system and platform 500 may include virtually any computing device capable of receiving and sending a message over a network (e.g., cloud network), such as network 505, to and from another computing device, such as servers 506 and 507, each other, and the like. In some embodiments, the connected devices 502 through 504 may be personal computers, multiprocessor systems, microprocessor-based or programmable consumer electronics, network PCs, and the like. In some embodiments, one or more connected devices within connected devices 502 through 504 may include IoT devices that typically connect using a wireless communications medium such as cell phones, smart phones, pagers, walkie talkies, radio frequency (RF) devices, infrared (IR) devices, CBs citizens band radio, integrated devices combining one or more of the preceding devices, or virtually any mobile computing device, and the like. In some embodiments, one or more connected devices within connected devices 502 through 504 may be devices that are capable of connecting using a wired or wireless communication medium such as a PDA, POCKET PC, wearable computer, a laptop, tablet, desktop computer, a netbook, a video game device, a pager, a smart phone, an ultra-mobile personal computer (UMPC), and/or any other device that is equipped to communicate over a wired and/or wireless communication medium (e.g., NFC, RFID, NBIOT, 3G, 4G, 5G, GSM, GPRS, WiFi, WiMax, CDMA, OFDM, OFDMA, LTE, satellite, ZigBee, etc.). In some embodiments, one or more connected devices within connected devices 502 through 504 may include may run one or more applications, such as Internet browsers, mobile applications, voice calls, video games, videoconferencing, and email, among others. In some embodiments, one or more connected devices within connected devices 502 through 504 may be configured to receive and to send web pages, and the like. In some embodiments, an exemplary specifically programmed browser application of the present disclosure may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In some embodiments, a connected device within connected devices 502 through 504 may be specifically programmed by either Java, . Net, QT, C, C++, Python, PHP and/or other suitable programming language. In some embodiment of the device software, device control may be distributed between multiple standalone applications. In some embodiments, software components/applications can be updated and redeployed remotely as individual units or as a full software suite. In some embodiments, a connected device may periodically report status or send alerts over text or email. In some embodiments, a connected device may contain a data recorder which is remotely downloadable by the user using network protocols such as FTP, SSH, or other file transfer mechanisms. In some embodiments, a connected device may provide several levels of user interface, for example, advance user, standard user. In some embodiments, one or more connected devices within connected devices 502 through 504 may be specifically programmed include or execute an application to perform a variety of possible tasks, such as, without limitation, messaging functionality, browsing, searching, playing, streaming or displaying various forms of content, including locally stored or uploaded messages, images and/or video, and/or games.

In some embodiments, the exemplary network 505 may provide network access, data transport and/or other services to any computing device coupled to it. In some embodiments, the exemplary network 505 may include and implement at least one specialized network architecture that may be based at least in part on one or more standards set by, for example, without limitation, Global System for Mobile communication (GSM) Association, the Internet Engineering Task Force (IETF), and the Worldwide Interoperability for Microwave Access (WiMAX) forum. In some embodiments, the exemplary network 505 may implement one or more of a GSM architecture, a General Packet Radio Service (GPRS) architecture, a Universal Mobile Telecommunications System (UMTS) architecture, and an evolution of UMTS referred to as Long Term Evolution (LTE). In some embodiments, the exemplary network 505 may include and implement, as an alternative or in conjunction with one or more of the above, a WiMAX architecture defined by the WiMAX forum. In some embodiments and, optionally, in combination of any embodiment described above or below, the exemplary network 505 may also include, for instance, at least one of a local area network (LAN), a wide area network (WAN), the Internet, a virtual LAN (VLAN), an enterprise LAN, a layer 3 virtual private network (VPN), an enterprise IP network, or any combination thereof. In some embodiments and, optionally, in combination of any embodiment described above or below, at least one computer network communication over the exemplary network 505 may be transmitted based at least in part on one of more communication modes such as but not limited to: NFC, RFID, Narrow Band Internet of Things (NBIOT), ZigBee, 3G, 4G, 5G, GSM, GPRS, WiFi, WiMax, CDMA, OFDM, OFDMA, LTE, satellite and any combination thereof. In some embodiments, the exemplary network 505 may also include mass storage, such as network attached storage (NAS), a storage area network (SAN), a content delivery network (CDN) or other forms of computer or machine readable media.

In some embodiments, the exemplary server 506 or the exemplary server 507 may be a web server (or a series of servers) running a network operating system, examples of which may include but are not limited to Apache on Linux or Microsoft IIS (Internet Information Services). In some embodiments, the exemplary server 506 or the exemplary server 507 may be used for and/or provide cloud and/or network computing, including, e.g., hosting the energy management system 110. Although not shown in FIG. 5, in some embodiments, the exemplary server 506 or the exemplary server 507 may have connections to external systems like email, SMS messaging, text messaging, ad content providers, etc. Any of the features of the exemplary server 506 may be also implemented in the exemplary server 507 and vice versa.

In some embodiments, one or more of the exemplary servers 506 and 507 may be specifically programmed to perform, in non-limiting example, as authentication servers, search servers, email servers, social networking services servers, Short Message Service (SMS) servers, Instant Messaging (IM) servers, Multimedia Messaging Service (MMS) servers, exchange servers, photo-sharing services servers, advertisement providing servers, financial/banking-related services servers, travel services servers, or any similarly suitable service-base servers for users of the connected devices 501 through 504.

In some embodiments and, optionally, in combination of any embodiment described above or below, for example, one or more exemplary computing connected devices 502 through 504, the exemplary server 506, and/or the exemplary server 507 may include a specifically programmed software module that may be configured to send, process, and receive information using a scripting language, a remote procedure call, an email, a tweet, Short Message Service (SMS), Multimedia Message Service (MMS), instant messaging (IM), an application programming interface, Simple Object Access Protocol (SOAP) methods, Common Object Request Broker Architecture (CORBA), HTTP (Hypertext Transfer Protocol), REST (Representational State Transfer), SOAP (Simple Object Transfer Protocol), MLLP (Minimum Lower Layer Protocol), or any combination thereof.

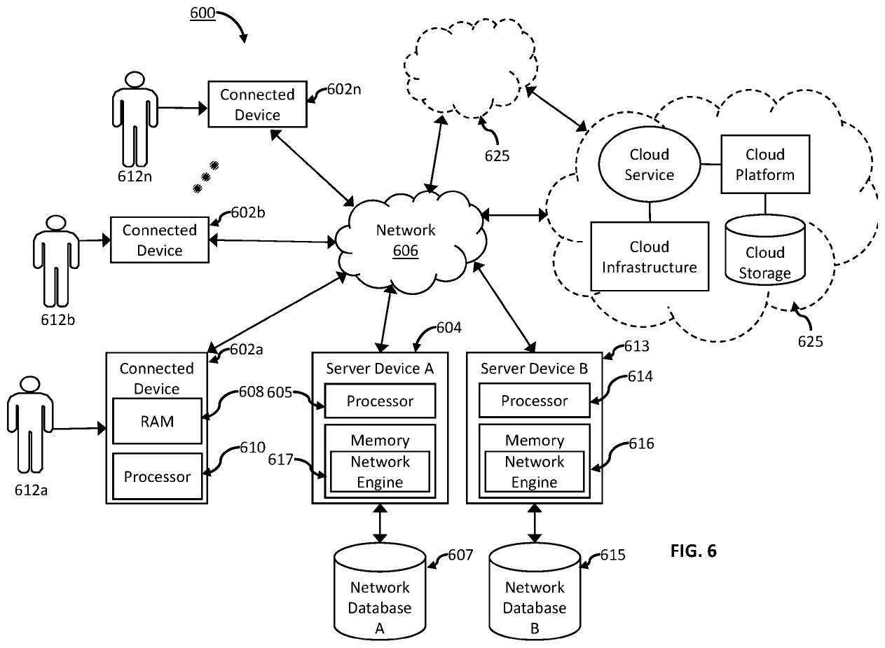

FIG. 6 depicts a block diagram of ecosystem 500 incorporating the energy management system 110 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the connected device 602a, connected device 602b through connected device 602n shown each at least includes a computer-readable medium, such as a random-access memory (RAM) 608 coupled to a processor 610 or FLASH memory. In some embodiments, the processor 610 may execute computer-executable program instructions stored in memory 608. In some embodiments, the processor 610 may include a microprocessor, an ASIC, and/or a state machine. In some embodiments, the processor 610 may include, or may be in communication with, media, for example computer-readable media, which stores instructions that, when executed by the processor 610, may cause the processor 610 to perform one or more steps described herein. In some embodiments, examples of computer-readable media may include, but are not limited to, an electronic, optical, magnetic, or other storage or transmission device capable of providing a processor, such as the processor 610 of connected device 602a, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and etc.

In some embodiments, connected devices 602a through 602n may also comprise a number of external or internal devices such as a mouse, a CD-ROM, DVD, a physical or virtual keyboard, a display, or other input or output devices. In some embodiments, examples of connected devices 602a through 602n (e.g., clients) may be any type of processor-based platforms that are connected to a network 606 such as, without limitation, personal computers, digital assistants, personal digital assistants, smart phones, pagers, digital tablets, laptop computers, Internet appliances, and other processor-based devices. In some embodiments, connected devices 602a through 602n may be specifically programmed with one or more application programs in accordance with one or more principles/methodologies detailed herein. In some embodiments, connected devices 602a through 602n may operate on any operating system capable of supporting a browser or browser-enabled application, such as Microsoft™, Windows™, and/or Linux. In some embodiments, connected devices 602a through 602n shown may include, for example, personal computers executing a browser application program such as Microsoft Corporation's Internet Explorer™, Apple Computer, Inc.'s Safari™, Mozilla Firefox, and/or Opera. In some embodiments, through the member computing connected devices 602a through 602n, user 612a, user 612b through user 612n, may communicate over the exemplary network 606 with each other and/or with other systems and/or devices coupled to the network 606. As shown in FIG. 6, exemplary server devices 604 and 613 may include processor 605 and processor 614, respectively, as well as memory 617 and memory 616, respectively. In some embodiments, the server devices 604 and 613 may be also coupled to the network 606. In some embodiments, one or more connected devices 602a through 602n may be mobile clients.

In some embodiments, at least one database of exemplary databases 607 and 615 may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

In some embodiments, the connected devices 602a through 602n and/or the server device A 604 and/or server device B 613 may be connected to one or more cloud computing systems 625. In some embodiments, the connected devices 602a through 602n may be associated with different ecosystems, such as, e.g., different smart home platforms (e.g., Apple Homekit™, Google Home™, Amazon Alexa™, Honeywell Home™, Resideo Connect™, GE Cync™, etc.), each platform being operated on a separate cloud computing system 625. Thus, the energy management system 110 may be incorporated into at least one of the cloud computing systems 625 such that the energy management system 110 may communicate, e.g., directly or via the network 606, with the smart home platform of each connected devices 602a through 602n rather than directly with each connected devices 602a through 602n itself, e.g., via a cloud-to-cloud ecosystem. Thus, energy management and optimization of connected devices 602a through 602n that are not directly compatible with the energy management system 110 or the cloud computing system 625 thereof may nevertheless be managed and optimized via cloud-to-cloud communication with the platform(s) associated with the connected devices 602a through 602n. In some embodiments, some or all connected devices 602a through 602n may in direct communication with the cloud computing system 625 of the energy management system 110, some or all of the connected devices 602a through 602n may be directly managed by a separate cloud computing system 625 from the cloud computing system 625 of the energy management system 110 such that the cloud computing system 625 of the energy management system 110 interfaces with the separate cloud computing system 625 to indirectly manage and control those some or all connected devices 602a through 602n, or any combination of direct and indirect management and optimization of the connected devices 602a through 602n.

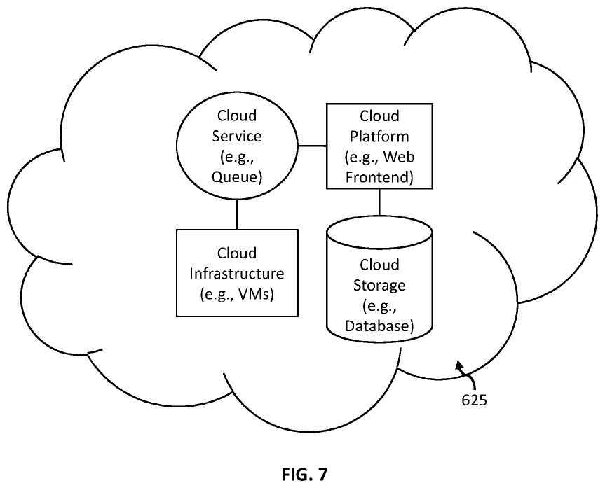

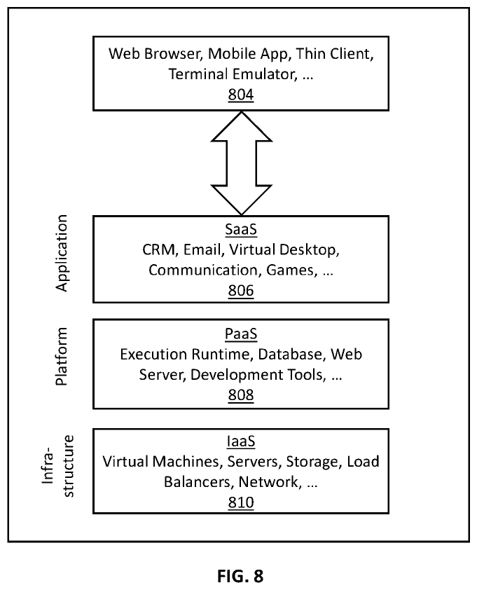

In some embodiments, the exemplary energy management system 110 of the present disclosure may be specifically configured to operate in a cloud computing system 625 having a cloud computing architecture such as, but not limiting to: infrastructure a service (IaaS) 810, platform as a service (PaaS) 808, and/or software as a service (Saas) 806 using a web browser, mobile app, thin client, terminal emulator or other endpoint 804. FIGS. 7 and 8 illustrate schematics of exemplary implementations of the cloud computing/architecture(s) in which the exemplary inventive computer-based systems/platforms, the exemplary inventive computer-based devices, and/or the exemplary inventive computer-based components of the present disclosure may be specifically configured to operate.

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a user interacting with an application on a mobile device) occurs, in order that results of the computation can be used in guiding the physical process.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, several hours, daily, several days, weekly, monthly, etc.

In some embodiments, exemplary inventive, specially programmed computing systems and platforms with associated devices are configured to operate in the distributed network environment, communicating with one another over one or more suitable data communication networks (e.g., the Internet, satellite, etc.) and utilizing one or more suitable data communication protocols/modes such as, without limitation, IPX/SPX, X.25, AX.25, AppleTalk™, TCP/IP (e.g., HTTP), near-field wireless communication (NFC), RFID, Narrow Band Internet of Things (NBIOT), 3G, 4G, 5G, GSM, GPRS, WiFi, WiMax, CDMA, satellite, ZigBee, and other suitable communication modes.

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, Javascript, Python, Perl, QT, etc.).

In some embodiments, one or more of illustrative computer-based systems or platforms of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

As used herein, term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

In some embodiments, as detailed herein, one or more of the computer-based systems of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a message, a map, an entire application (e.g., a calculator), data points, and other suitable data. In some embodiments, as detailed herein, one or more of the computer-based systems of the present disclosure may be implemented across one or more of various computer platforms such as, but not limited to: (1) FreeBSD, NetBSD, OpenBSD; (2) Linux; (3) Microsoft Windows™; (4) Open VMS™; (5) OS X (MacOS™); (6) UNIX™; (7) Android; (8) iOS™; (9) Embedded Linux; (10) Tizen™; (11) WebOS™; (12) Adobe AIR™; (13) Binary Runtime Environment for Wireless (BREW™); (14) Cocoa™ (API); (15) Cocoa™ Touch; (16) Java™Platforms; (17) JavaFX™; (18) QNX™; (19) Mono; (20) Google Blink; (21) Apple WebKit; (22) Mozilla Gecko™; (23) Mozilla XUL; (24) .NET Framework; (25) Silverlight™; (26) Open Web Platform; (27) Oracle Database; (28) Qt™; (29) SAP NetWeaver™; (30) Smartface™; (31) Vexi™; (32) Kubernetes™ and (33) Windows Runtime (WinRT™) or other suitable computer platforms or any combination thereof. In some embodiments, illustrative computer-based systems or platforms of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

In some embodiments, illustrative computer-based systems or platforms of the present disclosure may be configured to handle numerous concurrent users that may be, but is not limited to, at least 100 (e.g., but not limited to, 100-999), at least 1,000 (e.g., but not limited to, 1,000-9,999), at least 10,000 (e.g., but not limited to, 10,000-99,999) , at least 100,000 (e.g., but not limited to, 100,000-999,999), at least 1,000,000 (e.g., but not limited to, 1,000,000-9,999,999), at least 10,000,000 (e.g., but not limited to, 10,000,000-99,999,999), at least 100,000,000 (e.g., but not limited to, 100,000,000-999,999,999), at least 1,000,000,000 (e.g., but not limited to, 1,000,000,000-999,999,999,999), and so on.

In some embodiments, illustrative computer-based systems or platforms of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like. In various implementations, the display may be a holographic display. In various implementations, the display may be a transparent surface that may receive a visual projection. Such projections may convey various forms of information, images, or objects. For example, such projections may be a visual overlay for a mobile augmented reality (MAR) application.

In some embodiments, illustrative computer-based systems or platforms of the present disclosure may be configured to be utilized in various applications which may include, but not limited to, gaming, mobile-device games, video chats, video conferences, live video streaming, video streaming and/or augmented reality applications, mobile-device messenger applications, and others similarly suitable computer-device applications.

As used herein, the term “mobile electronic device,” or the like, may refer to any portable electronic device that may or may not be enabled with location tracking functionality (e.g., MAC address, Internet Protocol (IP) address, or the like). For example, a mobile electronic device can include, but is not limited to, a mobile phone, Personal Digital Assistant (PDA), Blackberry™, Pager, Smartphone, or any other reasonable mobile electronic device.

As used herein, terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user).

In some embodiments, the illustrative computer-based systems or platforms of the present disclosure may be configured to securely store and/or transmit data by utilizing one or more of encryption techniques (e.g., private/public key pair, Triple Data Encryption Standard (3DES), block cipher algorithms (e.g., IDEA, RC2, RC5, CAST and Skipjack), cryptographic hash algorithms (e.g., MD5, RIPEMD-160, RTRO, SHA-1, SHA-2, Tiger (TTH), WHIRLPOOL, RNGs).

As used herein, the term “user” shall have a meaning of at least one user. In some embodiments, the terms “user”, “subscriber” “consumer” or “customer” should be understood to refer to a user of an application or applications as described herein and/or a consumer of data supplied by a data provider. By way of example, and not limitation, the terms “user” or “subscriber” can refer to a person who receives data provided by the data or service provider over the Internet in a browser session, or can refer to an automated software application which receives the data and stores or processes the data.

The aforementioned examples are, of course, illustrative and not restrictive.

At least some aspects of the present disclosure will now be described with reference to the following numbered clauses.
Clause 1. A method comprising: receiving, by at least one processor, device use data from a plurality of connected devices in a predefined area; wherein the plurality of connected devices interface with the at least one processor via a network to enable the at least one processor to do at least one of the following: communicate with each connected device of the plurality of connected devices, or control each connected device of the plurality of connected devices; wherein the device use data comprises operational characteristics comprising at least one of: on/off time, runtime, operating mode, power/current draw, power state, or setpoint; determining, by the at least one processor, a time-based energy demand associated with each connected device based at least in part on the device use data; determining, by the at least one processor, at least one time-of-use metric associated with energy demand across the predefined area based at least in part on the time-based energy demand associated with each connected device; determining, by the at least one processor, that the at least one time-of-use metric exceeds a predetermined time-of-use threshold that represents a maximum energy demand allowable by the plurality of connected devices within a window of time; determining, by the at least one processor, a plurality of active connected device of the plurality of connected devices based at least in part on the device use data indicating active usage of the plurality of active connected devices during the window of time; determining, by the at least one processor, a priority rank representing an ordering of the plurality of active connected devices according to a priority of operation based at least in part on: a device type of each active connected device of the plurality of active connected devices, the time-based energy demand associated with each active connected device, and the window of time; determining, by the at least one processor, at least one active connected device of the plurality of active connected devices having a low power operating mode that consumes less power than a current operating mode at which the at least one active connected device is operating; and automatically instructing, by the at least one processor, a subset of the plurality of active connected devices to operate at the low power operating mode during the window of time based at least in part on the priority rank and the at least one active connected device having the low power operating mode so as to reduce energy demand within the predefined area during the time window.
Clause 2. The method of clause 1, wherein the plurality of active connected devices comprises at least one WiFi router.
Clause 3. The method of clause 1, further comprising: utilizing, by the at least one processor, at least one energy prediction model to predict a future time window energy metric associated with each connected device of the plurality of connected devices based at least in part on trained parameters and historical use data associated with the plurality of connected devices; determining, by the at least one processor, a priority rank representing an ordering of the plurality of active connected devices according to a priority of operation based at least in part on the future time window energy metric associated with each connected device.
Clause 4. The method of clause 1, further comprising: utilizing, by the at least one processor, at least one energy prediction model to predict the time-based energy demand associated with each connected device based at least in part on the device use data and trained parameters.
Clause 5. The method of clause 1, wherein the predefined area comprises a service area of a power supply company.
Clause 6. The method of clause 1, wherein the time-based energy demand comprises time-of-use energy demand.
Clause 7. The method of clause 1, further comprising automatically instructing, by the at least one processor, the subset of the plurality of active connected devices to operate at the low power operating mode to optimize at least one aspect of energy demand.
Clause 8. The method of clause 7, wherein the at least one aspect comprises energy demand variance.
Clause 9. The method of clause 7, wherein the at least one aspect comprises an energy demand peak.
Clause 10. The method of clause 1, further comprising: accessing, by the at least one processor, a device profile associated with each connected device, wherein the device profile comprises an energy demand associated with each operating mode; determining, by the at least one processor, a duration in each operating mode during the time window for each connected device; and determining, by the at least one processor, the at least one time-of-use metric for each connected device based at least in part on: the energy demand associated with each operating mode, and duration in each operating mode.
Clause 11. A system comprising: at least one processor in communication with at least one non-transitory computer-readable medium having software instructions stored thereon, wherein the at least one processor, upon execution of the software instructions, is configured to: receive device use data from a plurality of connected devices in a predefined area; wherein the plurality of connected devices interface with the at least one processor via a network to enable the at least one processor to do at least one of the following: communicate with each connected device of the plurality of connected devices, or control each connected device of the plurality of connected devices; wherein the device use data comprises operational characteristics comprising at least one of: on/off time, runtime, operating mode, power/current draw, power state, or setpoint; determine a time-based energy demand associated with each connected device based at least in part on the device use data; determine at least one time-of-use metric associated with energy demand across the predefined area based at least in part on the time-based energy demand associated with each connected device; determine that the at least one time-of-use metric exceeds a predetermined time-of-use threshold that represents a maximum energy demand allowable by the plurality of connected devices within a window of time; determine a plurality of active connected device of the plurality of connected devices based at least in part on the device use data indicating active usage of the plurality of active connected devices during the window of time; determine a priority rank representing an ordering of the plurality of active connected devices according to a priority of operation based at least in part on: a device type of each active connected device of the plurality of active connected devices, the time-based energy demand associated with each active connected device, and the window of time; determine at least one active connected device of the plurality of active connected devices having a low power operating mode that consumes less power than a current operating mode at which the at least one active connected device is operating; and automatically instruct a subset of the plurality of active connected devices to operate at the low power operating mode during the window of time based at least in part on the priority rank and the at least one active connected device having the low power operating mode so as to reduce energy demand within the predefined area during the time window.
Clause 12. The system of clause 11, wherein the plurality of active connected devices comprises at least one WiFi router.
Clause 13. The system of clause 11, wherein the at least one processor, upon execution of the software instructions, is further configured to: utilize at least one energy prediction model to predict a future time window energy metric associated with each connected device of the plurality of connected devices based at least in part on trained parameters and historical use data associated with the plurality of connected devices; determine a priority rank representing an ordering of the plurality of active connected devices according to a priority of operation based at least in part on the future time window energy metric associated with each connected device.
Clause 14. The system of clause 11, wherein the at least one processor, upon execution of the software instructions, is further configured to: utilize at least one energy prediction model to predict the time-based energy demand associated with each connected device based at least in part on the device use data and trained parameters.
Clause 15. The system of clause 11, wherein the predefined area comprises a service area of a power supply company.
Clause 16. The system of clause 11, wherein the time-based energy demand comprises time-of-use energy demand.
Clause 17. The system of clause 11, wherein the at least one processor, upon execution of the software instructions, is further configured to automatically instruct the subset of the plurality of active connected devices to operate at the low power operating mode to optimize at least one aspect of energy demand.
Clause 18. The system of clause 17, wherein the at least one aspect comprises energy demand variance.
Clause 19. The system of clause 17, wherein the at least one aspect comprises an energy demand peak.
Clause 20. The system of clause 11, wherein the at least one processor, upon execution of the software instructions, is further configured to: access a device profile associated with each connected device, wherein the device profile comprises an energy demand associated with each operating mode; determine a duration in each operating mode during the time window for each connected device; and determine the at least one time-of-use metric for each connected device based at least in part on: the energy demand associated with each operating mode, and duration in each operating mode.

Publications cited throughout this document are hereby incorporated by reference in their entirety. While one or more embodiments of the present disclosure have been described, it is understood that these embodiments are illustrative only, and not restrictive, and that many modifications may become apparent to those of ordinary skill in the art, including that various embodiments of the inventive methodologies, the illustrative systems and platforms, and the illustrative devices described herein can be utilized in any combination with each other. Further still, the various steps may be carried out in any desired order (and any desired steps may be added and/or any desired steps may be eliminated).

What is claimed is:

1. A method comprising:
receiving, by at least one processor, device use data from a plurality of connected devices in a predefined area;
wherein the plurality of connected devices interface with the at least one processor via a network to enable the at least one processor to do at least one of the following:
communicate with each connected device of the plurality of connected devices, or
control each connected device of the plurality of connected devices;
wherein the device use data comprises operational characteristics comprising at least one of:
on/off time,
runtime,
operating mode,
power/current draw,
power state, or
setpoint;
determining, by the at least one processor, a time-based energy demand associated with each connected device based at least in part on the device use data;
determining, by the at least one processor, at least one time-of-use metric associated with energy demand across the predefined area based at least in part on the time-based energy demand associated with each connected device;
determining, by the at least one processor, that the at least one time-of-use metric exceeds a predetermined time-of-use threshold that represents a maximum energy demand allowable by the plurality of connected devices within a window of time;
determining, by the at least one processor, a plurality of active connected device of the plurality of connected devices based at least in part on the device use data indicating active usage of the plurality of active connected devices during the window of time;
determining, by the at least one processor, a priority rank representing an ordering of the plurality of active connected devices according to a priority of operation based at least in part on:
a device type of each active connected device of the plurality of active connected devices,
the time-based energy demand associated with each active connected device, and
the window of time;
determining, by the at least one processor, at least one active connected device of the plurality of active connected devices having a low power operating mode that consumes less power than a current operating mode at which the at least one active connected device is operating; and
automatically instructing, by the at least one processor, a subset of the plurality of active connected devices to operate at the low power operating mode during the window of time based at least in part on the priority rank and the at least one active connected device having the low power operating mode so as to reduce energy demand within the predefined area during the time window.

2. The method of claim 1, wherein the plurality of active connected devices comprises at least one WiFi router.

3. The method of claim 1, further comprising:
utilizing, by the at least one processor, at least one energy prediction model to predict a future time window energy metric associated with each connected device of the plurality of connected devices based at least in part on trained parameters and historical use data associated with the plurality of connected devices;
determining, by the at least one processor, a priority rank representing an ordering of the plurality of active connected devices according to a priority of operation based at least in part on the future time window energy metric associated with each connected device.

4. The method of claim 1, further comprising:
utilizing, by the at least one processor, at least one energy prediction model to predict the time-based energy demand associated with each connected device based at least in part on the device use data and trained parameters.

5. The method of claim 1, wherein the predefined area comprises a service area of a power supply company.

6. The method of claim 1, wherein the time-based energy demand comprises time-of-use energy demand.

7. The method of claim 1, further comprising automatically instructing, by the at least one processor, the subset of the plurality of active connected devices to operate at the low power operating mode to optimize at least one aspect of energy demand.

8. The method of claim 7, wherein the at least one aspect comprises energy demand variance.

9. The method of claim 7, wherein the at least one aspect comprises an energy demand peak.

10. The method of claim 1, further comprising:
accessing, by the at least one processor, a device profile associated with each connected device, wherein the device profile comprises an energy demand associated with each operating mode;
determining, by the at least one processor, a duration in each operating mode during the time window for each connected device; and
determining, by the at least one processor, the at least one time-of-use metric for each connected device based at least in part on:
the energy demand associated with each operating mode, and
duration in each operating mode.

11. A system comprising:
at least one processor in communication with at least one non-transitory computer-readable medium having software instructions stored thereon, wherein the at least one processor, upon execution of the software instructions, is configured to:
receive device use data from a plurality of connected devices in a predefined area;
wherein the plurality of connected devices interface with the at least one processor via a network to enable the at least one processor to do at least one of the following:
communicate with each connected device of the plurality of connected devices, or
control each connected device of the plurality of connected devices;
wherein the device use data comprises operational characteristics comprising at least one of:
on/off time,
runtime,
operating mode,
power/current draw,
power state, or
setpoint;
determine a time-based energy demand associated with each connected device based at least in part on the device use data;
determine at least one time-of-use metric associated with energy demand across the predefined area based at least in part on the time-based energy demand associated with each connected device;
determine that the at least one time-of-use metric exceeds a predetermined time-of-use threshold that represents a maximum energy demand allowable by the plurality of connected devices within a window of time;
determine a plurality of active connected device of the plurality of connected devices based at least in part on the device use data indicating active usage of the plurality of active connected devices during the window of time;
determine a priority rank representing an ordering of the plurality of active connected devices according to a priority of operation based at least in part on:
a device type of each active connected device of the plurality of active connected devices,
the time-based energy demand associated with each active connected device, and
the window of time;
determine at least one active connected device of the plurality of active connected devices having a low power operating mode that consumes less power than a current operating mode at which the at least one active connected device is operating; and
automatically instruct a subset of the plurality of active connected devices to operate at the low power operating mode during the window of time based at least in part on the priority rank and the at least one active connected device having the low power operating mode so as to reduce energy demand within the predefined area during the time window.

12. The system of claim 11, wherein the plurality of active connected devices comprises at least one WiFi router.

13. The system of claim 11, wherein the at least one processor, upon execution of the software instructions, is further configured to:
utilize at least one energy prediction model to predict a future time window energy metric associated with each connected device of the plurality of connected devices based at least in part on trained parameters and historical use data associated with the plurality of connected devices;
determine a priority rank representing an ordering of the plurality of active connected devices according to a priority of operation based at least in part on the future time window energy metric associated with each connected device.

14. The system of claim 11, wherein the at least one processor, upon execution of the software instructions, is further configured to:
utilize at least one energy prediction model to predict the time-based energy demand associated with each connected device based at least in part on the device use data and trained parameters.

15. The system of claim 11, wherein the predefined area comprises a service area of a power supply company.

16. The system of claim 11, wherein the time-based energy demand comprises time-of-use energy demand.

17. The system of claim 11, wherein the at least one processor, upon execution of the software instructions, is further configured to automatically instruct the subset of the plurality of active connected devices to operate at the low power operating mode to optimize at least one aspect of energy demand.

18. The system of claim 17, wherein the at least one aspect comprises energy demand variance.

19. The system of claim 17, wherein the at least one aspect comprises an energy demand peak.

20. The system of claim 11, wherein the at least one processor, upon execution of the software instructions, is further configured to:
access a device profile associated with each connected device, wherein the device profile comprises an energy demand associated with each operating mode;
determine a duration in each operating mode during the time window for each connected device; and
determine the at least one time-of-use metric for each connected device based at least in part on:
the energy demand associated with each operating mode, and
duration in each operating mode.
